(19) United States
(12) Patent Application Publication
(10) Pub. No.: US 2026/0098534 A1
(43) Pub. Date: Apr. 9, 2026

(54) JOURNAL BEARING HAVING WEAR REDUCTION SLOTS ON AN END FACE

(71) Applicant: Eaton Intelligent Power Limited, Dublin (IE)

(72) Inventors: Jubin Tom GEORGE, Manganam (IN); Steven RILEY, Hindhead (GB); Simon MARTIN-DYE, Avon, OH (US)

(21) Appl. No.: 19/345,260

(22) Filed: Sep. 30, 2025

(30) Foreign Application Priority Data
Oct. 4, 2024 (IN) 202411075034

(51) Int. Cl. F04C 2/08; F16C 17/02

(52) U.S. Cl. CPC F04C 2/084; F16C 17/02; F04C 2240/54; F16C 2360/00

(57) ABSTRACT

Slots are provided in end faces of bearings in a transition region thereof. The slots improve the balance of hydrostatic and hydrodynamic forces between the bearing and a gear provided on a journal supported by the bearing, thereby improving film thickness and providing increased force at smaller clearances. The slots reduce wear occurring on the end face resulting from operation of the gear pump under higher pressure conditions.

### CROSS-REFERENCE TO RELATED APPLICATIONS

The present application claims priority to Indian Provisional Patent Application, Ser. No. 202411075034, entitled JOURNAL BEARING HAVING WEAR REDUCTION SLOTS ON AN END FACE, filed Oct. 4, 2024, which is herein incorporated by reference in its entirety.

### BACKGROUND

Fuel pumps may have various stages including a gear stage. Journal bearings are provided along one or more gear sets of the gear stage. The journal bearings radially support the gear sets within an outer housing. The journal bearings also axially support gears of the gear sets within the outer housing and provide at least some sealing against fluid leakage at the gears. To provide this sealing, a first axial force is applied to movable ones of the journal bearings to press the journal bearings towards the gears relative to the outer housing. This pressure can cause increased wear to occur at the faces of the journal bearings facing the gears.

### SUMMARY

Some aspects of the disclosure are directed to one or more journal bearings for a gear stage of a pump (e.g., a fuel pump). The journal bearings support a journal driving the rotation of a gear of the gear stage. The journal bearings have end faces facing the gear of the gear stage. The end faces include a transition region between an inlet and a discharge arc with respect to the rotation of the gears. The end faces include a plurality of slots provided in the transition region. The slots provide improved film thickness and pressure balance on the end face. The improvements to film thickness and pressure balance can increase the force at the transition region separating the gear from the bearing, particularly as clearances between gear and bearing become smaller, thereby reducing wear occurring at the end face of the bearings as a result of operations, particularly under high-pressure conditions.

In an embodiment, a gear stage for a pump includes a housing defining a gear chamber. The housing further defines an inlet and an outlet in fluid communication with the gear chamber. The gear stage further includes a gear arrangement disposed within the gear chamber configured to drive fluid from the inlet to the outlet. The gear arrangement includes at least a gear rotatable about an axis of rotation. The gear stage also includes a journal coupled to the gear, the journal extending along the axis of rotation and being configured to drive rotation of the gear about the axis of rotation. The gear arrangement further includes a fixed bearing at a first axial side of the gear for radially supporting the journal relative to the housing such that the journal is rotatable about the axis of rotation relative to the housing, and an axially movable bearing at an opposite second axial side of the gear for radially supporting the journal relative to the housing such that the journal is rotatable about the axis of rotation relative to the housing. The axially movable bearing defines a through-bore for receiving the journal. The axially movable bearing is axially movable along axis of rotation within the journal toward and away from the gear. The axially movable bearing is rotationally fixed relative to the housing. At least one of the fixed bearings and the axially movable bearing includes an end face including a transition region between an inlet region of said bearing and a discharge arc of said bearing, the end face of said bearing including a plurality of slots formed in the transition region.

In an embodiment, a bearing for a gear stage of a pump includes a body defining a through-bore extending along a longitudinal axis between a first axial end and a second axial end, the second axial end including an end face. The end face is configured to face a gear of the gear stage of the pump. The end face includes a transition region between an inlet region of said bearing and a discharge arc of the bearing. The end face of the bearing includes a plurality of slots formed in the transition region.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example fuel pump including a gear stage configured in accordance with the principles of the present disclosure;

FIG. 2 is a longitudinal cross-section of the fuel pump of FIG. 1;

FIG. 3 is a transverse cross-section of the gear stage of the fuel pump of FIG. 1;

FIG. 4 shows components of the gear stage exploded outwardly from an outer housing of the fuel pump of FIG. 1;

FIG. 5 is a longitudinal cross-section of the gear stage of the fuel pump of FIG. 1 including first and second gear sets, each gear set including a gear, a fixed bearing, and a movable bearing;

FIG. 6 illustrates an example movable bearing for use in a first gear set of the fuel pump of FIG. 1, the movable bearing of the second gear set being a mirror image;

FIG. 7 illustrates an example fixed bearing for use in a first gear set of the fuel pump of FIG. 1, the movable bearing of the second gear set being a mirror image;

FIG. 8 illustrates an example end face of a bearing;

FIG. 9 illustrates another example end face of a bearing;

FIG. 10 illustrates another example end face of a bearing.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

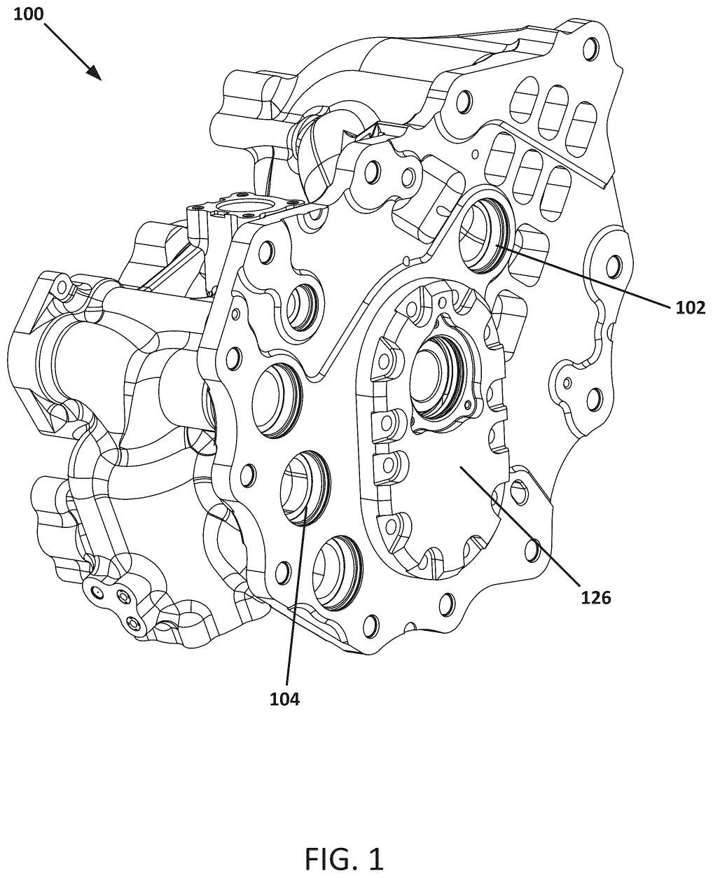

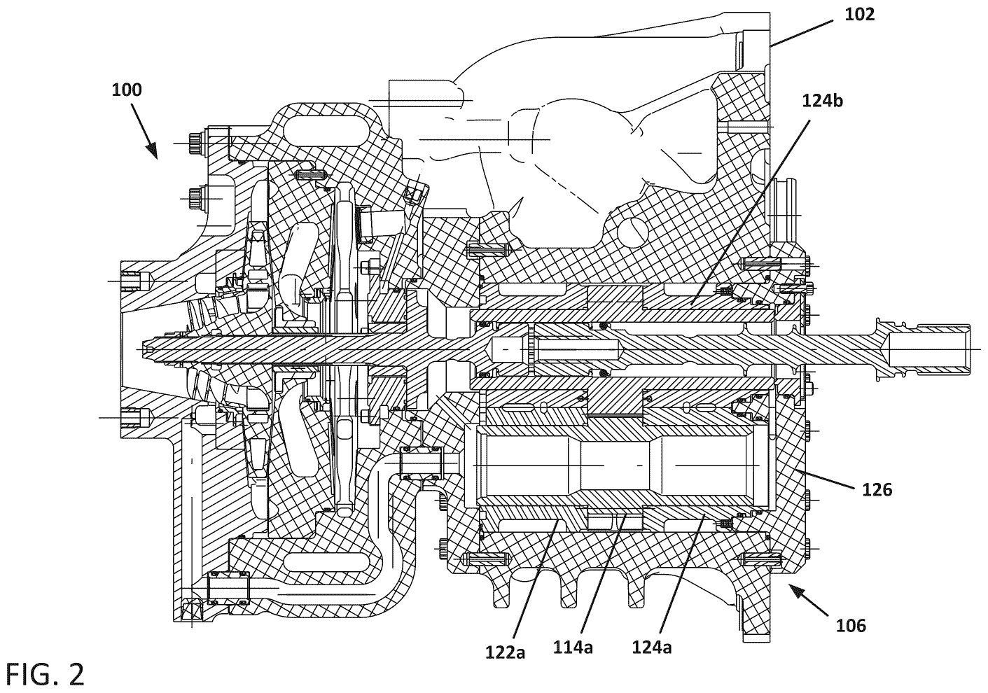

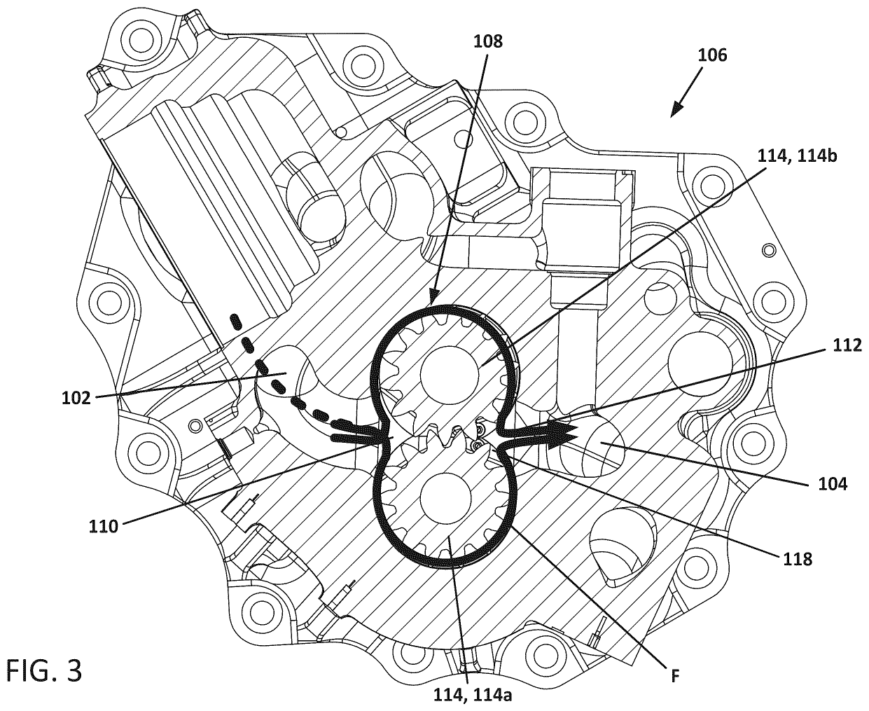

FIG. 1 illustrates a fuel pump 100 for use with an engine. The fuel pump 100 drives fluid (e.g., fuel) from an inlet 102 to an outlet 104 with one or more stages. For example, referring to FIGS. 2 and 3, the pump 100 includes a gear stage 106 having an outer housing 116 defining a gear chamber 118. The inlet 102 leads to an inlet region of the gear chamber 118; the outlet 104 leads to a discharge region 112 of the gear chamber 118. A gear arrangement 108 is disposed within the gear chamber 118 and drives fluid from the inlet region 110 to the discharge region 112.

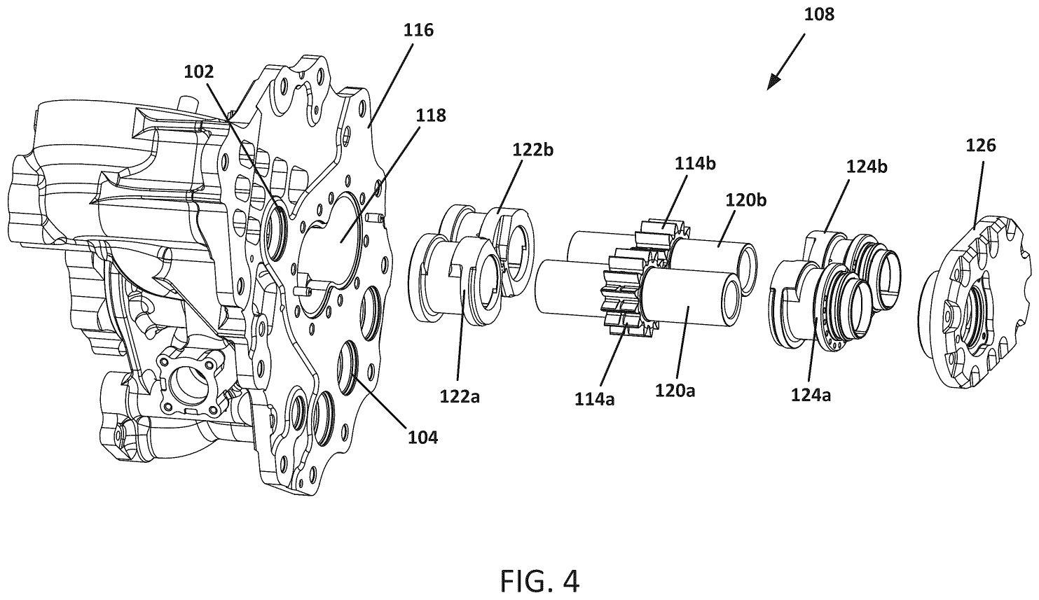

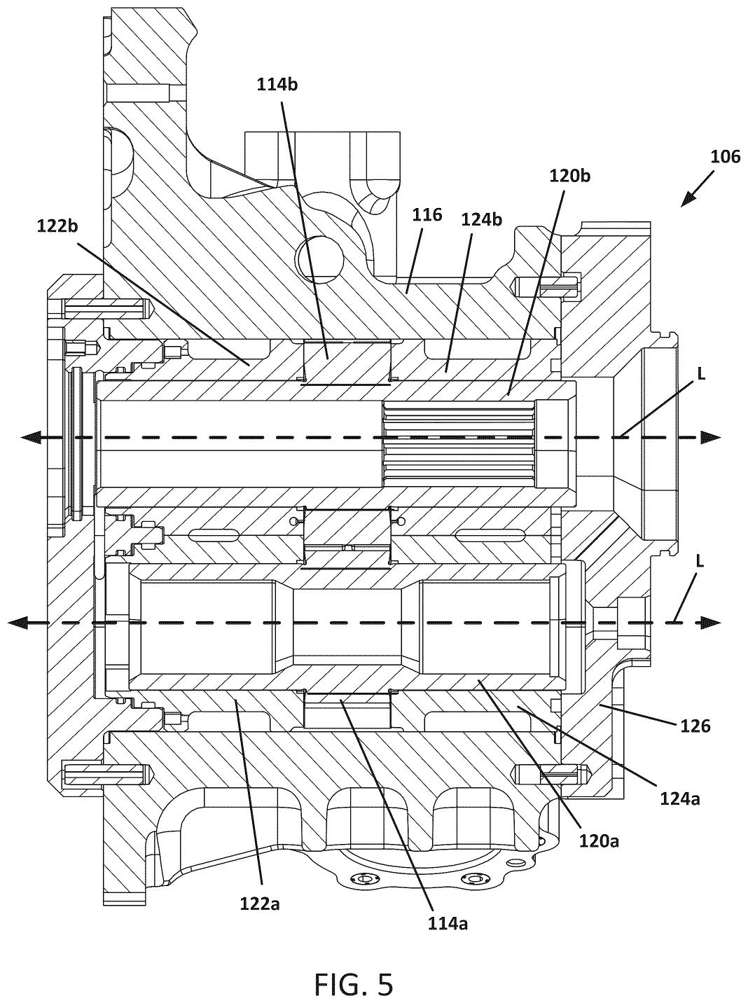

As shown in FIGS. 4 and 5, the gear chamber 118 extends along a longitudinal axis L. The gear arrangement 108 is disposed within the gear chamber 118. The gear arrangement 108 includes a first gear set including a journal 120 extending axially within the gear chamber 118 along the longitudinal axis L. A gear 114 of the first gear set is rotatably mounted over the journal 120. First and second bearings 122, 124 are mounted over the journal 120 at opposite sides of the gear 114 to radially support the journal 120 relative to the housing 116 such that the journal 120 is rotatable about the longitudinal axis L relative to the housing 116. The first and second bearings 122, 124 are rotationally fixed relative to each other and to the outer housing 116. An end cap 126 mounts to the housing 116 to close the gear chamber 118.

In certain implementations, the components are formed from different materials. For example, the gears 114a, 114b may be formed of a different metal than the movable bearings 124a, 124b and/or the housing 116. Accordingly, thermal variations have different effects on the components. To compensate, the second bearings 124a, 124b are axially movable along the journal to accommodate thermal expansion and contraction during operation of the pump 100. The first bearing 122 is both axially and rotationally fixed relative to the journal 120.

In certain implementations, the gear arrangement 108 includes two gear sets disposed in parallel within the gear chamber 118. Each of the first sets includes a respective gear 114a, 114b, a respective journal 120a, 120b extending along a respective longitudinal axis, a respective fixed bearing 122a, 122b, and a respective movable bearing 124a, 124b of the gear arrangement 108. The gear chamber 118 is shaped to accommodate both gear sets. In the example shown, the gear chamber 118 has a peanut shaped transverse cross-section. The gear sets are disposed sufficiently close together so that at least the second bearings 124a, 124b contact each other as will be described in more detail herein. As shown in FIG. 3, the first and second gears 114a, 114b mesh together at a region in alignment with the inlet region 110 and the discharge region 112. The teeth of the gears 114a, 114b draw fluid from the inlet region 110, along a flow path F extending between the gear teeth and the cavity 118, to the discharge region 112.

While a majority of the fluid is driven to the outlet 104 through the discharge region 112, at least some of the fluid leaks along the gear chamber 118 (e.g., to the movable bearings 124a, 124b). Fluid leaking from the inlet region 110 has a first pressure. Fluid leaking from the discharge region 112 has a second pressure that is greater than the first pressure. To reduce leakage, the movable bearings 124a, 124b are biased against the respective gears 114a, 114b. Accordingly, each gear 114a, 114b is clamped between the fixed bearing 122a, 122b and the movable bearing 124a, 124b by the biasing force being applied to the movable bearing 124a, 124b.

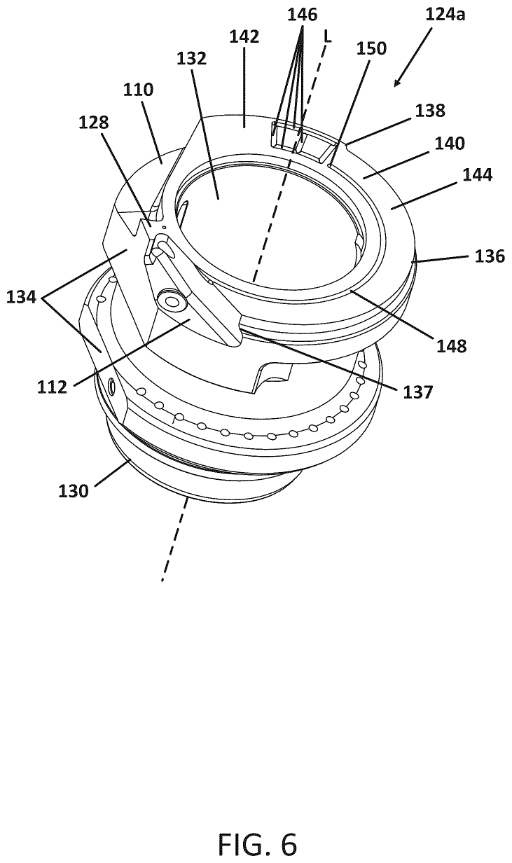

FIG. 6 shows a first movable bearing 124a; the second movable bearing 124b of the pump 100 can be a mirror image of first movable bearing 124a. As shown in FIG. 6, each movable bearing 124a, 124b defines a through-bore 132 for receiving the respective journal 120a, 120b. The through-bore 132 extends between a first axial end 128 and a second axial end 130 of the axially moveable bearing 124a, 124b. The first axial end 128 faces the axial side of the respective gear 114a, 114b and the second axial end 130 faces away from the respective gear 114a, 114b. Each movable bearing 124a, 124b defines flat surfaces 134 facing transverse to the longitudinal axis L. The flat surfaces 134 are configured to engage each other when the movable bearings 124a, 124b are mounted to the respective journals 120a, 120b within the gear chamber 118. Engagement of the flat surfaces 134 inhibits rotation of the movable bearings 124a, 124b about the journals 120a, 120b. The inlet region 110 is disposed at one side of the flat surfaces 134 and the discharge region 112 is disposed at the opposite side of the flat surfaces 134.

Each movable bearing 124a, 124b defines an outer channel 136 extending circumferentially around a section of the outer circumferential portion at the first axial end 128. The outer channel 136 has a first end 137 in fluid pressure communication with the discharge region 112. The outer channel 136 extends circumferentially around the movable bearing 124a, 124b from the first end 137 to an opposite second end 138 that terminates before reaching the flat surface 134. Accordingly, the outer channel 136 provides discharge fluid pressure along the section of the outer circumferential portion at the first axial end 128.

Each movable bearing 124a, 124b includes an end face 140 at the first axial end 128. The respective end faces 140 of movable bearings 124a, 124b can be mirror images of one another. End face 140 includes a discharge arc 144 extending circumferentially over the length of the outer channel 136. The end face 140 includes a transition region 142 extending circumferentially along the end face 140 between the inlet region 110 and second end 138 of outer channel 136, and radially from an inner perimeter of end face 140 to an outer perimeter thereof. Transition region 142 is a region of the pump 100 where a pressure of the fluid is increased from an inlet pressure to a discharge pressure. Transition region 142 can have an angular width of more than two times an angular width of a tooth-to-tooth spacing of a corresponding gear 114a, 114b. In an embodiment, transition region 142 has an angular width in a range from 2 to 2.5 times an angular width of a tooth-to-tooth spacing of the gear.

Slots 146 can be provided in the transition region 142 of the end face 140. The slots 146 can have sufficient width and depth to allow fluid communication. In an embodiment, slots 146 are provided entirely within the perimeter of the end face 140. In an embodiment, the slots do not extend to either of bore 132 or an outer surface of the movable bearing 124a, 124b between the first axial end 128 and second axial end 130. In an embodiment, slots 146 can be provided entirely within the transition region 142 of the end face 140. In an embodiment, the slots 146 are positioned on end face 140 such that slots 146 are provided radially outward of roots of the teeth of the respective gear 114a, 114b when the respective journal 120a, 120b thereof is received in the bore 132. In an embodiment, slots 146 can each extend in a direction radially outwards with respect to the longitudinal axis L. In an embodiment, slots 146 can extend in a direction inclined with respect to a radial direction extending from the longitudinal axis L. In an embodiment, at least some of slots 146 extend in a circumferential direction with respect to longitudinal axis L. In an embodiment, slots 146 extending in the circumferential direction connect one or more slots 146 extending radially outwards with respect to the longitudinal axis L and/or one or more slots 146 extending in a direction inclined with respect to a radial direction extending from the longitudinal axis L. In an embodiment, the one or more slots 146 can be positioned in a portion of the transition region 142 sealed from inlet region 110 by one or more teeth of the gear 114 during operation of the pump 100. The one or more slots 146 can be positioned spaced apart from the inlet region 110 of the movable bearing 124a, 124b by at least an angular width of a tooth-to-tooth spacing of the respective gear 114a, 114b.

A groove 148 can be provided in the end face 140. The groove 148 can extend along end face circumferentially with respect to the longitudinal axis L to discharge region 112. The groove 148 can extend a length of the discharge arc 144. In an embodiment, groove 148 terminates at an end 150 within the discharge arc 144. In an embodiment, groove 148 can connect to one or more of the slots 146. In an embodiment, the groove 148 and the slots 146 are separated on the end face 140. In certain examples, groove 148 extends along the same section as the outer channel 136 so that the end 150 of the groove 148 is offset radially inwardly from the second end 138 of the outer channel 136. In certain implementations, the groove 148 is disposed in line with the roots of the teeth of the respective gear 114a, 114b so that fluid pressure beneath the teeth of the gear 114a, 114b is relatively constant (e.g., at discharge pressure).

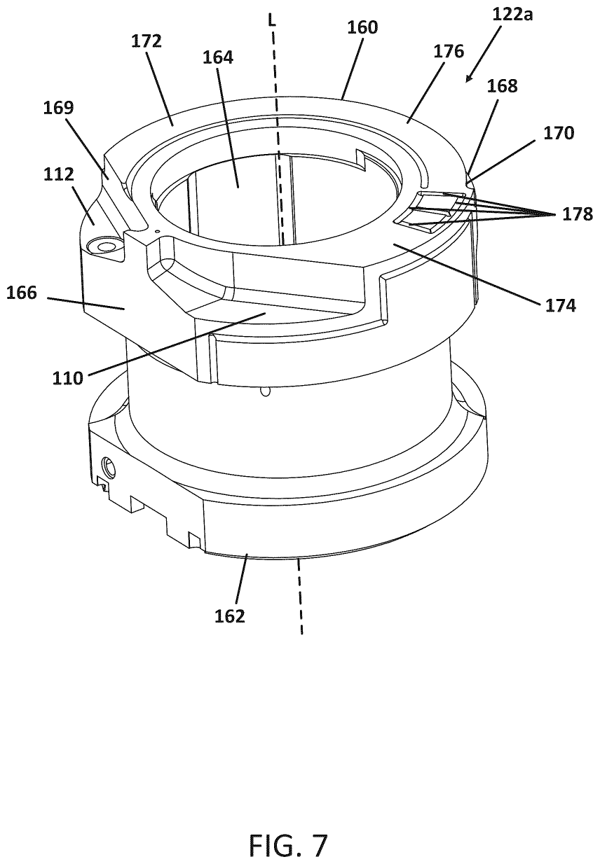

FIG. 7 shows a first fixed bearing 122a; the second fixed bearing 122b of the pump 100 can be a mirror image of first fixed bearing 122a. As shown in FIG. 7, each fixed bearing 122a, 122b defines a through-bore 164 for receiving another portion of the respective journal 120a, 120b. The through-bore 164 extends between a first axial end 160 and a second axial end 162 of the fixed bearing 122a, 122b. The first axial end 160 faces the axial side of the respective gear 114a, 114b and the second axial end 162 faces away from the respective gear 114a, 114b. Each fixed bearing 122a, 122b defines flat surfaces 166 facing transverse to the longitudinal axis L. The flat surfaces 166 are configured to engage each other when the fixed bearings 122a, 122b are mounted to the respective journals 120a, 120b within the gear chamber 118. Engagement of the flat surfaces 166 inhibits rotation of the fixed bearings 122a, 122b about the journals 120a, 120b. The inlet region 110 is disposed at one side of the flat surfaces 166 and the discharge region 112 is disposed at the opposite side of the flat surfaces 166.

Each fixed bearing 122a, 122b defines an outer channel 168 extending circumferentially around a section of the outer circumferential portion at the first axial end 160. The outer channel 168 has a first end 169 in fluid pressure communication with the discharge region 112. The outer channel 168 extends circumferentially around the fixed bearing 122a, 122b from the first end 169 to an opposite second end 170 that terminates before reaching the flat surface 166. Accordingly, the outer channel 168 provides discharge fluid pressure along the section of the outer circumferential portion at the first axial end 160.

Each fixed bearing 122a, 122b includes an end face 172 at the first axial end 160. The respective end faces 172 of movable bearings 122a, 122b can be mirror images of one another. End face 172 includes a discharge arc 176 extending circumferentially over the length of the outer channel 168. The end face 172 includes a transition region 174 extending circumferentially along the end face 172 between the inlet region 110 and second end 170 of outer channel 168, and radially from an inner perimeter of end face 172 to an outer perimeter thereof. Transition region 174 is a region of the pump 100 where a pressure of the fluid is increased from an inlet pressure to a discharge pressure. Transition region 174 can have an angular width of more than two times an angular width of a tooth-to-tooth spacing of a corresponding gear 114a, 114b. In an embodiment, transition region 174 has an angular width in a range from 2 to 2.5 times an angular width of a tooth-to-tooth spacing of the gear.

Slots 178 can be provided in the transition region 174 of the end face 172. The slots 178 can have sufficient width and depth to allow fluid communication. In an embodiment, slots 178 are provided entirely within the perimeter of the end face 172. In an embodiment, the slots do not extend to either of bore 164 or an outer surface of the movable bearing 122a, 122b between the first axial end 160 and second axial end 162. In an embodiment, slots 178 can be provided entirely within the transition region 174 of the end face 172. In an embodiment, the slots 178 are positioned on end face 172 such that slots 178 are provided radially outward of roots of the teeth of the respective gear 114a, 114b when the respective journal 120a, 120b thereof is received in the bore 164. In an embodiment, slots 178 can each extend in a direction radially outwards with respect to the longitudinal axis L. In an embodiment, slots 178 can extend in a direction inclined with respect to a radial direction extending from the longitudinal axis L. In an embodiment, at least some of slots 178 extend in a circumferential direction with respect to longitudinal axis L. In an embodiment, slots 178 extending in the circumferential direction connect one or more slots 178 extending radially outwards with respect to the longitudinal axis L and/or one or more slots 178 extending in a direction inclined with respect to a radial direction extending from the longitudinal axis L. In an embodiment, the one or more slots 178 can be positioned in a portion of the transition region 174 sealed from inlet region 110 by one or more teeth of the gear 114 during operation of the pump 100. The one or more slots 178 can be positioned spaced apart from the inlet region 110 of the fixed bearing 122a, 122b by at least an angular width of a tooth-to-tooth spacing of the respective gear 114a, 114b.

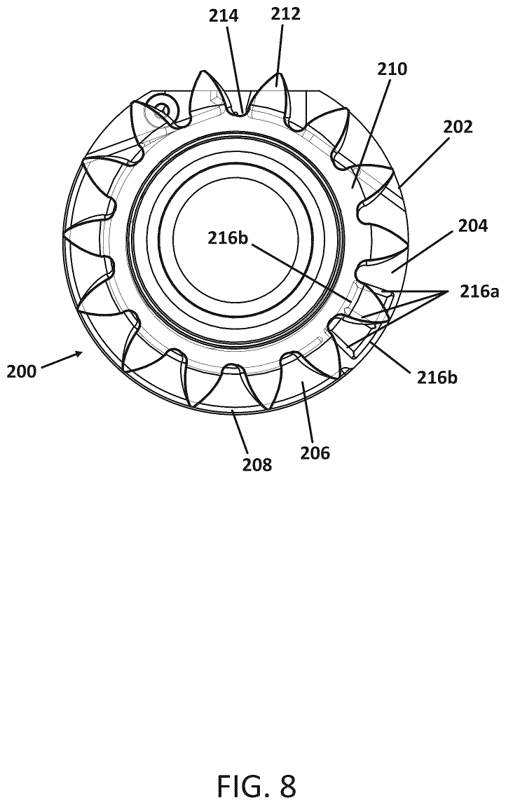

FIG. 8 illustrates an example end face of a bearing and a corresponding gear for use in one of the first and second gear sets, the end face of another such bearing being a mirror image. End face 200 or a mirror image thereof can be provided at a face of fixed bearings 122a, 122b facing towards the respective gears 114a, 114b, and/or at a face of movable bearings 124a, 124b facing towards the respective gears 114a, 114b. Gear 210 is shown superposed over the end face 200. Gear 210 can be, for example, one of gears 114a, 114b as described above and shown in FIGS. 2-5. Gear 210 includes teeth 212 extending from roots 214.

End face 200 includes intake region 202, transition region 204, and discharge arc 206. Inlet region 202 is defined by the intake, such as the intake region 110 described above and shown in FIGS. 3, 6, and 7. Discharge arc 206 is a region of end face 200 exposed to discharge fluid pressure by outer channel 208 formed in a portion of the bearing including end face 200. The outer channel 208 extends from the end 209 to a discharge region of the bearing including the end face 200. Transition region 204 is a region between intake region 202 and discharge arc 206 where a pressure of the fluid is increased from an inlet pressure to a discharge pressure. Transition region 204 can be over an area of end face 200 from where the teeth 212 begins to seal a chamber from the inlet region as gear 210 rotates to where the teeth 212 no longer seal the chamber due to the passing over end 209 of the outer channel 208.

Slots 216a and 216b are provided in transition region 204 on the end face 200. Slots 216a, 216b have sufficient width and depth to allow fluid communication. In an embodiment, slots 216a, 216b are provided entirely within the perimeter of the end face 200. In an embodiment, slots 216a, 216b can be provided entirely within the transition region 204 of the end face 200. Slots 216a each extend radially away from the axis of rotation of the gear 210. Slots 216b each extend circumferentially over at least a portion of transition region 204. In an embodiment, an innermost of slots 216b can be positioned radially outwards of the roots 214 of gear 210. Slots 216b can connect two or more of the slots 216a. In an embodiment, one or more of slots 216b can extend greater than an angular width of teeth 212 of the gear 210, thereby allowing one or more of the teeth 212 to be bypassed by way of the slot 216b. At least some of the slots 216a, 216b can be positioned to intermittently be exposed to discharge fluid pressure from the discharge arc 206 based on the position of teeth 212 of the gear 210. Connections among slots 216a, 216b can allow all such connected slots 216a, 216b to experience discharge fluid pressure as a result of such intermittent exposure to the discharge fluid pressure. In an embodiment, three radially extending slots 216a can be provided, with the radially extending slots 216a being connected by circumferential slots 216b extending along the innermost and outermost ends of the radially extending slots 216a.

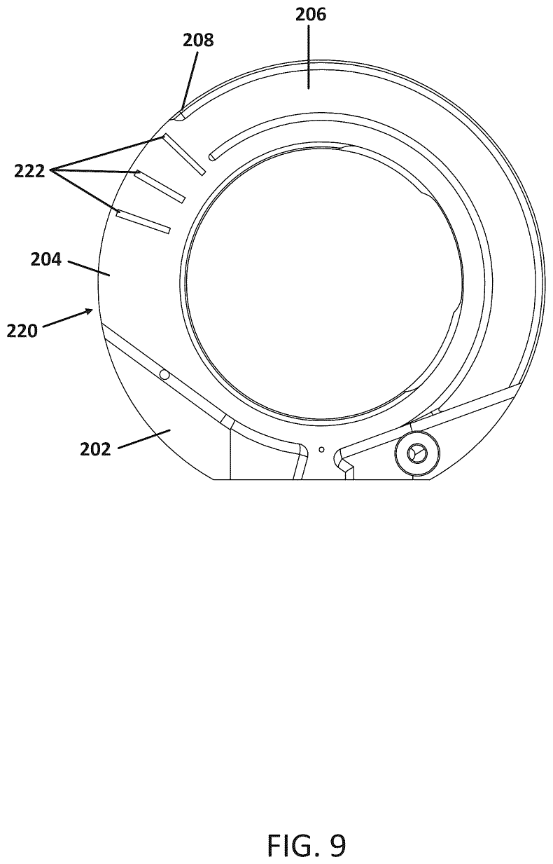

FIG. 9 illustrates an end face of another example bearing for use in one of the first and second gear sets, the end face of another such bearing being a mirror image. End face 220 or a mirror image thereof can be provided at a face of fixed bearings 122a, 122b facing towards the respective gears 114a, 114b, and/or at a face of movable bearings 124a, 124b facing towards the respective gears 114a, 114b. End face 220 includes intake region 202, transition region 204, discharge arc 206, and outer channel 208 as described above. Gear 210, as described above and shown in FIG. 8, can be used with the bearing including end face 220.

Slots 222 are provided in transition region 204 of end face 220. Slots 222 have sufficient width and depth to allow fluid communication. In an embodiment, slots 222 are provided entirely within the perimeter of the end face 220. In an embodiment, slots 222 can be provided entirely within the transition region 204 of the end face 220. Each of slots 222 extends radially away from the axis of rotation of the gear 210. Slots 222 can be distributed over the transition region 204 or a portion thereof. The slots 222 can extend in the radial direction outwards from the roots 214 of the teeth of gear 210. In an embodiment, slots 222 reach an end prior to reaching an outer perimeter of the end face 220. At least one of slots 222 can be positioned proximate to the discharge arc 206 such that when the bearing including end face 220 is used with gear 210, said slot 222 is intermittently exposed to discharge fluid pressure from the discharge arc 206 based on the position of teeth 212 of the gear 210.

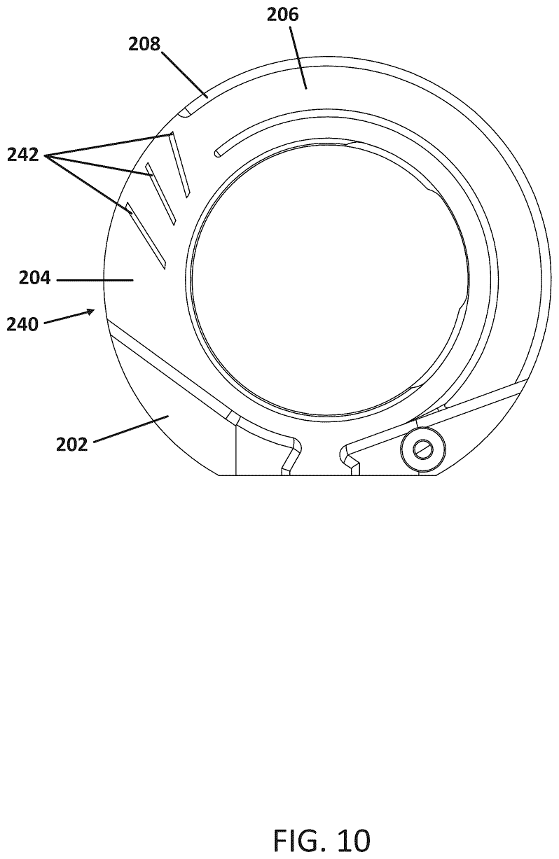

FIG. 10 illustrates an end face of a further example bearing for use in one of the first and second gear sets, the end face of another such bearing being a mirror image. End face 240 or a mirror image thereof can be provided at a face of fixed bearings 122a, 122b facing towards the respective gears 114a, 114b, and/or at a face of movable bearings 124a, 124b facing towards the respective gears 114a, 114b. End face 240 includes intake region 202, transition region 204, discharge arc 206, and outer channel 208 as described above. Gear 210, as described above and shown in FIG. 8, can be used with the bearing including end face 240.

Slots 242 are provided in transition region 204 of end face 240. Slots 242 have sufficient width and depth to allow fluid communication. In an embodiment, slots 242 are provided entirely within the perimeter of the end face 240. In an embodiment, slots 242 can be provided entirely within the transition region 204 of the end face 240. Each of slots 242 extends inclined with respect to a radial direction extending from the axis of rotation. In an embodiment, the angle of the incline with respect to the radial direction can be the same for each of slots 242. In an embodiment, the angle of the incline with respect to the radial direction can differ between at least two of the slots 242. In an embodiment, slots 242 do not extend in the circumferential direction by more than an angular width of one of the teeth 212 when the bearing including end face 240 is used with gear 210. In an embodiment, the extent of the incline can be such that when the bearing including end face 240 is used with gear 210, one or more of the slots 242 can provide a bypass allowing at least intermittent fluid communication across one or more of the teeth 212 of gear 210, based on the rotational position of the gear 210. In an embodiment, at least one of the slots 242 is positioned such that said slot 242 can be intermittently exposed to discharge fluid pressure from the discharge arc 206 based on the position of the gear 210 when the bearing including end face 240 is used with gear 210.

### ASPECTS OF THE DISCLOSURE

Aspect 1. A gear stage of a pump comprising:
a housing defining a gear chamber, the housing defining an inlet and an outlet in fluid communication with the gear chamber;
a gear arrangement disposed within the gear chamber configured to drive fluid from the inlet to the outlet, the gear arrangement including at least a gear rotatable about an axis of rotation;
a journal coupled to the gear, the journal extending along the axis of rotation and being configured to drive rotation of the gear about the axis of rotation;
a fixed bearing at a first axial side of the gear for radially supporting the journal relative to the housing such that the journal is rotatable about the axis of rotation relative to the housing; and
an axially movable bearing at an opposite second axial side of the gear for radially supporting the journal relative to the housing such that the journal is rotatable about the axis of rotation relative to the housing, the axially movable bearing defining a through-bore for receiving the journal, the axially movable bearing being axially movable along axis of rotation within the journal toward and away from the gear, the axially movable bearing being rotationally fixed relative to the housing;
wherein:
at least one of the fixed bearing and the axially movable bearing includes an end face facing the gear, the end face including a transition region between an inlet region of said bearing and a discharge arc of said bearing, the end face including a plurality of slots formed in the transition region.

Aspect 2. The gear stage of the pump according to aspect 1, wherein each of the plurality of slots are positioned radially outwards of a root of a tooth of the gear with respect to the axis of rotation.

Aspect 3. The gear stage of the pump according to any of aspects 1-2, wherein each of the plurality of slots are entirely within the transition region of the end face.

Aspect 4. The gear stage of the pump according to any of aspects 1-3, wherein each of the plurality of slots extend radially outwards with respect to the axis of rotation.

Aspect 5. The gear stage of the pump according to any of aspects 1-3, wherein each of the plurality of slots extend in a direction inclined with respect to a radial direction extending from the axis of rotation.

Aspect 6. The gear stage of the pump according to aspect 5, wherein each of the plurality of slots are inclined such that one or more of the plurality of slots can provide a bypass allowing fluid communication across a tooth of a gear.

Aspect 7. The gear stage of the pump according to any of aspects 1-6, wherein each of the plurality of slots are connected to one another by at least one slot extending in a circumferential direction with respect to the axis of rotation.

Aspect 8. The gear stage of the pump according to any of aspects 1-7, wherein the plurality of slots are spaced apart from the inlet region of said bearing by at least an angular width of a tooth-to-tooth spacing of the gear.

Aspect 9. The gear stage of the pump according to any of aspects 1-8, wherein the end face further includes a circumferential groove extending in a circumferential direction with respect to the axis of rotation, the circumferential groove in fluid communication with a discharge fluid pressure of the gear stage of the pump.

Aspect 10. The gear stage of the pump according to aspect 9, wherein each of the plurality of slots are separate from the circumferential groove on the end face.

Aspect 11. The gear stage of according to any of aspects 1-10, wherein the end face is a first end face, the plurality of slots is a first plurality of slots, and wherein the other of the fixed bearing and the axially movable bearing includes a second end face including a second transition region between an inlet region of said bearing and a discharge arc of said bearing, the second end face of said bearing including a second plurality of slots formed in the second transition region.

Aspect 12. The gear stage of the pump according to any of aspects 1-11, wherein the journal is a first journal, the fixed bearing is a first fixed bearing, and the axially movable bearing is a first axially movable bearing, the gear stage further comprising:
a second journal extending parallel to the first journal, the second journal driving another part of the gear arrangement;
a second fixed mounted over the second journal at the first axial side of the gear arrangement; and
a second axially movable bearing mounted over the second journal at the second axial side of the gear arrangement.

Aspect 13. The gear stage according to aspect 12, wherein the end face is a first end face, the plurality of slots is a first plurality of slots, and wherein at least one of the second fixed bearing and the second axially movable bearing includes a second end face including a second transition region between an inlet region of said bearing and a discharge arc of said bearing, the second end face of said bearing including a second plurality of slots formed in the second transition region.

Aspect 14. A pump, including the gear stage of the pump according to any of aspects 1-13.

Aspect 15. A bearing for a gear stage of a pump, the bearing including:
a body defining a through-bore extending along a longitudinal axis between a first axial end and a second axial end, the second axial end including an end face, wherein:
the end face is configured to face a gear of the gear stage of the pump,
the end face includes a transition region between an inlet region of said bearing and a discharge arc of the bearing, and
the end face of the bearing includes a plurality of slots formed in the transition region.

Aspect 16. The bearing for a gear stage of a pump according to aspect 15, each of the plurality of slots are entirely within the transition region of the end face.

Aspect 17. The bearing for a gear stage of a pump according to any of aspects 15-16, wherein each of the plurality of slots are connected to one another by at least one slot extending in a circumferential direction with respect to the longitudinal axis.

Aspect 18. The bearing for a gear stage of a pump according to any of aspects 15-17, wherein each of the plurality of slots extend radially outwards with respect to the longitudinal axis.

Aspect 19. The bearing for a gear stage of a pump according to any of aspects 15-17, wherein each of the plurality of slots extend in a direction inclined with respect to a radial direction extending from the longitudinal axis.

Aspect 20. The bearing for a gear stage of a pump according to any of aspects 15-19, wherein the end face further includes a groove extending in a circumferential direction with respect to the longitudinal axis, the groove in fluid communication with a discharge fluid pressure of the gear stage of the pump.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A gear stage of a pump comprising:
a housing defining a gear chamber, the housing defining an inlet and an outlet in fluid communication with the gear chamber;
a gear arrangement disposed within the gear chamber configured to drive fluid from the inlet to the outlet, the gear arrangement including at least a gear rotatable about an axis of rotation;
a journal coupled to the gear, the journal extending along the axis of rotation and being configured to drive rotation of the gear about the axis of rotation;
a fixed bearing at a first axial side of the gear for radially supporting the journal relative to the housing such that the journal is rotatable about the axis of rotation relative to the housing; and
an axially movable bearing at an opposite second axial side of the gear for radially supporting the journal relative to the housing such that the journal is rotatable about the axis of rotation relative to the housing, the axially movable bearing defining a through-bore for receiving the journal, the axially movable bearing being axially movable along axis of rotation within the journal toward and away from the gear, the axially movable bearing being rotationally fixed relative to the housing;
wherein:
at least one of the fixed bearing and the axially movable bearing includes an end face facing the gear, the end face including a transition region between an inlet region of said bearing and a discharge arc of said bearing, the end face including a plurality of slots formed in the transition region.

2. The gear stage of the pump of claim 1, wherein each of the plurality of slots are positioned radially outwards of a root of a tooth of the gear with respect to the axis of rotation.

3. The gear stage of the pump of claim 1, wherein each of the plurality of slots are entirely within the transition region of the end face.

4. The gear stage of the pump of claim 1, wherein each of the plurality of slots extend radially outwards with respect to the axis of rotation.

5. The gear stage of the pump of claim 1, wherein each of the plurality of slots extend in a direction inclined with respect to a radial direction extending from the axis of rotation.

6. The gear stage of the pump of claim 5, wherein each of the plurality of slots are inclined such that one or more of the plurality of slots can provide a bypass allowing fluid communication across a tooth of a gear.

7. The gear stage of the pump of claim 1, wherein each of the plurality of slots are connected to one another by at least one slot extending in a circumferential direction with respect to the axis of rotation.

8. The gear stage of the pump of claim 1, wherein the plurality of slots are spaced apart from the inlet region of said bearing by at least an angular width of a tooth-to-tooth spacing of the gear.

9. The gear stage of the pump of claim 1, wherein the end face further includes a first circumferential groove in fluid communication with a discharge fluid pressure of the gear stage of the pump.

10. The gear stage of the pump of claim 9, wherein each of the plurality of slots are separated from the first circumferential groove on the end face.

11. The gear stage of the pump of claim 1, wherein the end face is a first end face, the plurality of slots is a first plurality of slots, and wherein the other of the fixed bearing and the axially movable bearing includes a second end face including a second transition region between an inlet region of said bearing and a discharge arc of said bearing, the second end face of said bearing including a second plurality of slots formed in the second transition region.

12. The gear stage of the pump of claim 1, wherein the journal is a first journal, the fixed bearing is a first fixed bearing, and the axially movable bearing is a first axially movable bearing, the gear stage further comprising:
a second journal extending parallel to the first journal, the second journal driving another part of the gear arrangement;
a second fixed mounted over the second journal at the first axial side of the gear arrangement; and
a second axially movable bearing mounted over the second journal at the second axial side of the gear arrangement.

13. The gear stage of the pump of claim 12, wherein the end face is a first end face, the plurality of slots is a first plurality of slots, and wherein at least one of the second fixed bearing and the second axially movable bearing includes a second end face including a second transition region between an inlet region of said bearing and a discharge arc of said bearing, the second end face of said bearing including a second plurality of slots formed in the second transition region.

14. A pump, including the gear stage of the pump of claim 1.

15. A bearing for a gear stage of a pump, the bearing including:
a body defining a through-bore extending along a longitudinal axis between a first axial end and a second axial end, the second axial end including an end face, wherein:
the end face is configured to face a gear of the gear stage of the pump,
the end face includes a transition region between an inlet region of said bearing and a discharge arc of the bearing, and
the end face of the bearing includes a plurality of slots formed in the transition region.

16. The bearing for a gear stage of a pump of claim 15, each of the plurality of slots are entirely within the transition region of the end face.

17. The bearing for a gear stage of a pump of claim 15, wherein each of the plurality of slots are connected to one another by at least one slot extending in a circumferential direction with respect to the longitudinal axis.

18. The bearing for a gear stage of a pump of claim 15, wherein each of the plurality of slots extend radially outwards with respect to the longitudinal axis.

19. The bearing for a gear stage of a pump of claim 15, wherein each of the plurality of slots extend in a direction inclined with respect to a radial direction extending from the longitudinal axis.

20. The bearing for a gear stage of a pump of claim 15, wherein the end face further includes a groove extending in a circumferential direction with respect to the longitudinal axis, the groove in fluid communication with a discharge pressure of the gear stage of the pump.
